(19) United States
(12) Patent Application Publication
(10) Pub. No.: US 2026/0006356 A1
(43) Pub. Date: Jan. 1, 2026

(54) Enhancing real-time multi-layer assurance on packet over optical networks with AI large language models and cognitive search

(71) Applicant: Ciena Corporation, Hanover, MD (US)

(72) Inventors: Mohammad Reza Rokui, Ottawa (CA); John Dell, Ottawa (CA); Richard Kung, Ottawa (CA)

(73) Assignee: Ciena Corporation, Hanover, MD (US)

(21) Appl. No.: 18/756,953

(22) Filed: Jun. 27, 2024

(51) Int. Cl. H04Q 11/00

(52) U.S. Cl. CPC H04Q 11/0066; H04Q 2011/0081; H04Q 2011/0083

(57) ABSTRACT

Systems, methods, and non-transitory computer-readable media are provided for conducting user query searches for performing network assurance queries. According to one implementation, a method includes a step of receiving a user query regarding network assurance for ensuring that a network domain is operating reliably, wherein the user query relates to one of finding an issue in the network domain, understating the issue, and determining corrective actions for the issue. The method also includes a step of obtaining real-time telemetry information and inventory information associated with the network domain. Also, the method includes a step of using the real-time telemetry information and inventory information to create an enhanced user query. The method further includes a step of feeding the enhanced user query to an Artificial Intelligence (AI) network assurance solution.

### FIELD OF THE DISCLOSURE

The present disclosure generally relates to Artificial Intelligence (AI)/Generative AI (Gen-AI)-based real-time multi-layer network assurance systems and methods. More particularly, the present disclosure relates to the application of Large Language Models (LLM) and Semantic search to provide real-time network assurance.

### BACKGROUND

Network management and control tools may be used within an enterprise for troubleshooting a network domain that is specifically associated with the enterprise. Some tools may include the generation of alarms when issues are discovered and the clearing of alarms when the issues are resolved. Other tools may include root cause analysis to reduce the set of alarms that a troubleshooter needs to be concerned with. Still other tools may include forecasting techniques for predicting when Performance Monitoring (PM) thresholds are expected to be crossed by identifying trends in historical data. The purpose of many of these tools is to provide network assurance to thereby ensure that a network domain operates optimally, reliably, and securely. AI-based approaches may be used for recommending actions to be taken to address network assurance goals.

### BRIEF SUMMARY

In various embodiments, the present disclosure includes a process having steps for conducting a query search, a system including at least one processor and memory with instructions that, when executed, cause the at least one processor to implement the steps for conducting the query search, and a non-transitory computer-readable medium having instructions stored thereon for programming at least one processor to perform the steps for conducting the query search.

According to one implementation, a method for performing a query search regarding network assurance of a network domain is provided. The method includes a step of receiving a user query regarding network assurance for ensuring that a network domain is operating reliably. The method also includes a step of obtaining real-time telemetry information and inventory information associated with the network domain. In addition, the method includes using the real-time telemetry information and inventory information to create an enhanced user query. The method further includes a step of feeding the enhanced user query to an AI/Gen-AI based real-time multi-layer network assurance solution, which is referred to herein as an AI network assurance solution. Specifically, the AI network assurance solution can be implemented as a software tool, program, etc.

According to some embodiments, the method may further include a step of feeding enterprise content stored in a knowledge base to the AI network assurance solution, where the enterprise content includes one or more of proprietary technical specifications, internal articles, internal collaboration data, and customer data. The method may also include a step of providing metadata to the knowledge base to enhance the enterprise content based on results from the AI network assurance solution provided in response to the user query.

In some embodiments, the AI network assurance solution may be configured to troubleshoot the network domain, determine one or more issues regarding the network domain, and enable the manual or automatic resolution of one or more issues. The AI network assurance solution may include a Large Language Model (LLM) and a Cognitive Search module. In some implementations, the AI network assurance solution may include a Retrieval-Augmented Generation (RAG) component configured to obtain relevant context from the network domain. The network domain may be a packet-over-optical domain arranged at multiple layers. The inventory information may define network equipment and software release data at each of the multiple layers. The step of creating the enhanced user query may further include a step of adding useful insights based on one or more characteristics of the network domain.

The real-time telemetry information may include Performance Monitoring (PM) data measured with respect to Network Elements (NEs) and links connecting the NEs, thereby enabling the AI network assurance solution to determine one or more proactive problems. The real-time telemetry information may also include one or more alarm events representing one or more potential issues in the network domain, thereby enabling the AI network assurance solution to determine one or more reactive problems. The method may further include a step of detecting the network assurance by determining one or more of optimizations of the network domain, security of the network domain, health of the network domain, fault management of the network domain, and configuration or capacity planning of the network domain. The AI network assurance solution may be part of a Software-Defined Networking (SDN) controller.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram illustrating a query system, according to various embodiments of the present disclosure.

FIG. 2 is a block diagram illustrating a computing system of a user device for entering a query, according to various embodiments.

FIG. 3 is a block diagram illustrating a computing system of a server or retriever for answering a user's query, according to various embodiments.

FIG. 4 is a diagram illustrating an example of a multi-layer network including Internet Protocol (IP) and Multi-Protocol Label Switching (MPLS) packet equipment operating over an optical network.

FIG. 5 is a block diagram illustrating an enterprise system in which a query system enables a user to inquire about a network domain, according to various embodiments of the present disclosure.

FIG. 6 is a flow diagram illustrating a network assurance use case related to finding an issue in the network domain.

FIG. 7 is a flow diagram illustrating a corrective action use case related to determining corrective actions for any issue in the network domain.

FIG. 8 is a screenshot illustrating a graphical representation of search results associated with the network domain shown in FIG. 4, according to various embodiments.

FIG. 9 is a screenshot illustrating an example of a user interface showing results of a search query, according to various embodiments.

FIG. 10 is a screenshot illustrating a graphical representation of more search results associated with the network domain shown in FIG. 4, according to various embodiments.

FIG. 11 is a diagram illustrating a search system, according to various embodiments.

FIG. 12 is a flow diagram illustrating a method for performing a query search regarding network assurance of a network domain, according to various embodiments of the present disclosure.

### DETAILED DESCRIPTION

Normally, Performance Monitoring (PM) of network components is used for network assurance such as debugging and troubleshooting, which can lead to detection of network issues and methods for how the issues can be resolved. However, the PM data can also be used, as described in the present disclosure, for supplementing a query search. In addition, the query search can also be augmented by other aspects of the packet over optical network such as multi-layer network topology, alarm notifications, and network elements' information such as node type, their current configuration and other capabilities. In this way, when a query is directed to an enterprise network, which may include proprietary components and information, a search engine may be able to provide better search results based on knowledge of network equipment, topology, and real-time conditions of a network or enterprise domain. Therefore, the systems and methods described herein may be configured to incorporate various concepts of network troubleshooting into search tools to thereby take advantage of the detailed network analysis results when a search is performed.

A Large Language Model (LLM) is an Artificial Intelligence (AI) model with the ability to perform various Natural Language Processing (NLP) functions, such as Generative AI (GenAI) processes. An LLM can be extremely powerful at answering questions about publicly available data on which it has been trained. However, when a query involves a question about private information excluded from a pre-training step, the LLM may have difficulty providing an appropriate answer.

The present disclosure relates to systems and methods for performing search queries for a user. Query systems described herein may include Large Language Models (LLMs) and Generative Artificial Intelligence (GenAI).

### Query System

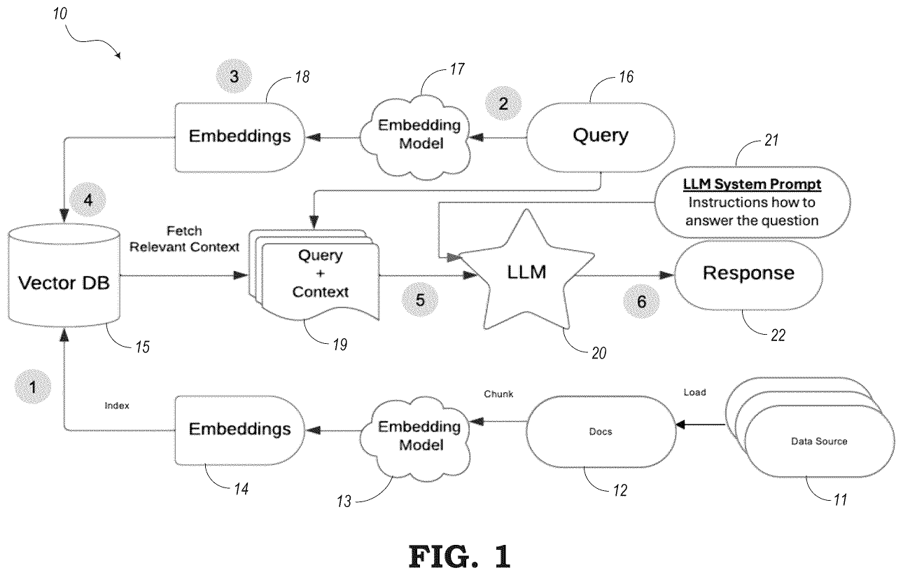

FIG. 1 is a diagram illustrating an embodiment of a query system 10, which may be configured as a GenAI documentation query system. As shown in FIG. 1, the query system 10 involves a data source 11 loading documents (docs) 12 to an embedding model 13. The docs 12 may be presented to the embedding model 13 according to a section-based process or chunking process, where a relevant section of the data source 11 is provided. The embedding model 13 may be configured to create embeddings 14 or chunks, which can be indexed or embedded into a vector databased 15 or query engine.

A query 16 (e.g., obtained from a user device) is input to another embedding model 17, which is configured to provide embeddings 18 to the vector database 15. Next, a query and context unit 19 is configured to receive the query 16 and then fetch relevant context from the vector database 15 to provide the context to an LLM 20. An LLM system prompt 21, which includes instructions about how to answer the query 16, is also provided to the LLM 20. At this point, the LLM 20 provides a response 22 to the user's query.

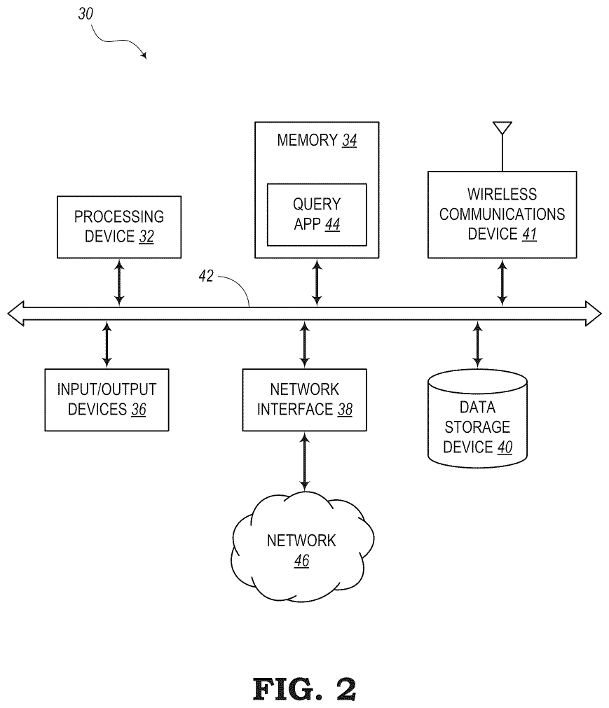

FIG. 2 is a block diagram illustrating an embodiment of a computing system 30 associated with a user device for entering a query. The computer system 30 includes a processing device 32, memory 34, Input/Output (I/O) devices 36, a network interface 38, a data storage device 40, and a wireless communications device 41 (e.g., radio system, cellular communications system, Wi-Fi communications system, Bluetooth system, etc.). The computer system 30 is configured to perform various functions and tasks through the coordinated operation of its constituent components 32, 34, 36, 38, 40, 41 via a suitable local bus interface 42. In operation, the computer system 30 may be configured to utilize its processing capabilities, memory resources, input/output interfaces, network connectivity, data storage, and wireless communications to execute software applications, process data, interact with users, and exchange information with external devices and networks.

The processing device 32, such as a central processing unit (CPU), executes instructions stored in memory 34 to carry out computational tasks and to manage the operation of the computer system 30. The memory 34 includes volatile and non-volatile storage components, providing temporary storage for data and instructions during execution. It comprises random access memory (RAM) for fast access and read-only memory (ROM) for storing essential system software. The computer system 30 may be configured to interface with users and external peripherals through the I/O devices 36. For example, input devices may include keyboards, mice, touchscreens, and other sensors, while output devices may encompass displays, printers, speakers, actuators, etc.

The network interface 38 may be configured to facilitate communication with external networks and devices, such as network 46 (e.g., the Internet). The network interface 38 enables the computer system 30 to send and receive data over wired or wireless connections. It supports various communication protocols such as Ethernet, Wi-Fi, Bluetooth, and cellular networks. The data storage device 40 (e.g., database, data store, etc.) is configured to store persistent data and system files, providing long-term storage capacity. It may include hard disk drives (HDDs), solid-state drives (SSDs), optical discs, and/or cloud storage services. The wireless communications device 41 may be configured to allow the computer system 30 to transmit and receive data wirelessly over radio frequencies, such as by using one or more antennas. It may be configured to support various communications standards, such as IEEE 802.11 (Wi-Fi), Bluetooth, cellular technologies, etc., enabling connectivity to wireless networks and peripheral devices.

The computing system 30 may include a query app 44 for enabling the user 12 to search for information, such as in the form of a natural language query normally associated with LLMs. The query app 44 may be incorporated in the memory 34 as software or firmware and/or may be incorporated in the processing device 32 as hardware. When implemented as software or firmware, the query app 44 may include computer-readable logic stored in a non-transitory computer-readable medium, whereby the logic may include instructions enabling or causing the processing device 32 to perform various functions as described in the present disclosure for conducting a search query for the user 12. As described with respect to FIG. 1, the query may be communicated in any suitable manner to the server 30, which can perform specific searches, as described with respect to the various embodiments of the present disclosure, and then provide an appropriate answer to the query.

### Server and Receiver

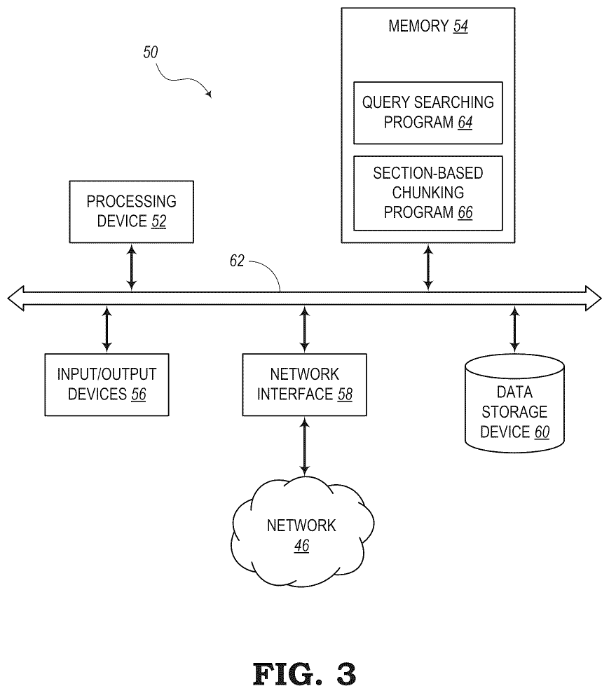

FIG. 3 is a block diagram illustrating a computing system 50, which may represent the components and functionality of one or both of the server 16 and/or retriever 18. The computer system 50 includes a processing device 52, memory 54, I/O devices 56, a network interface 58, and a data storage device 60. The computer system 50 is configured to perform various functions and tasks through the coordinated operation of its constituent components 52, 54, 56, 58, 60 via a local bus interface 62 in a manner similar to the procedures described with respect to the computing system 30 of FIG. 2. In operation, the computer system 50 may also be configured to utilize its processing capabilities, memory resources, input/output interfaces, network connectivity, and data storage to execute software applications, process data, interact with users, and exchange information with external devices and networks.

Furthermore, the computing system 50 includes a query searching program 64 configured to perform search functions based on a query received from corresponding user devices. Also, the computing system 50 includes a section-based chunking program 66 configured to retrieve relevant information (e.g., using RAG methods) from a vector database (e.g., vector store 15) when a search query involves specific reference to private information that is not normally publicly available. The programs 64, 66 may be stored in memory 54 or other non-transitory computer-readable media and may include instructions for enabling the processing device 52 to perform the searching and chunking functionality described herein.

In particular, the systems and methods of the present disclosure are configured to use the inherent structure of a document to provide a more complete context as a complete section of the documentation. Exploiting the structure of documents allows the dividing of the information into distinct sections. The query searching program 64 and section-based chunking program 66 can be run as software on any server (e.g., server 16, retriever 18, etc.) with sufficient resources and access to the LLM 20 (either via an external API or a locally deployed model) and access to a set of documentation (via the vector store 15 or other suitable database). The programs 64, 66 employed herein can consider the structure of the documentation when returning the context to the LLM 20.

Also, those skilled in the art will appreciate while the computing system 50 is illustrated as a single device that the present disclosure contemplates any implementation for implementing the functions of the server 16, the retriever 18, the vector store 20, and the LLM 22. That is, these can be deployed in a cloud via cloud services, across multiple machines, virtual machines, clusters, etc.

### Search Query Regarding Network Assurance

Furthermore, the embodiments described below are directed to searching techniques in which real-time aspects of the packet over optical network Performance Monitoring (PM) data, multi-layer network topology of packet over optical network, network elements' information, such as node type and their capabilities and alarm notifications, can be used to enhance a search query, particularly when the search is directed within the realm of “network assurance.” For example, network assurance, in the context of network control and management, may refer to processes, tools, and methodologies used to ensure that a network operates optimally, reliably, and securely. Network assurance may encompass a variety of practices aimed at maintaining the health and performance of a network, providing visibility into network operations, and proactively identifying and resolving issues before they affect users or services.

In particular, network assurance may include PM, which may include continuously tracking the performance of network devices, links, and services to ensure they meet required standards. This may include monitoring metrics such as bandwidth usage, latency, packet loss, and jitter. Also, network assurance may include fault management, which may include detecting, isolating, and resolving network issues that can impact performance. This may involve using tools to identify failures or degradations in the network and taking corrective actions to restore normal operations. Also, network assurance may include configuration management to ensure that network devices are configured correctly. For example, this may include managing device configurations, keeping track of changes, and ensuring compliance with policies and standards.

Other aspects of the packet over optical networks can also be detected and used for enhancing multi-layer assurance, such as:
network topology of packet over optical network
network elements' information such as node type and their capabilities and their current configuration
alarm notifications.

In addition, network assurance may also include security strategies for protecting the network from unauthorized access, attacks, and vulnerabilities. This may involve monitoring the network for potential security threats, implementing security policies, and ensuring that security measures are effective. Network assurance may also include capacity planning, service assurance, analytics, reporting, and other actions for maintaining a high level of network performance and reliability to support business operations and deliver good user experiences.

With respect to the embodiments described above, documentation can be fed with the query into the LLM. At the broadest level, the embodiments described below may include feeding a current real-time network context with a query related to network assurance into an LLM. As such, the added network context is configured to enable the search engine or LLM to create a better answer. The embodiments described below may be configured to be used with RAG as well, according to various embodiments.

In some cases, systems and methods may be configured to recommend certain actions based on detected properties of a network. Action recommendation systems may use an Artificial Intelligence (AI) model (e.g., Deep Neural Network (DNN)) with telemetry input (e.g., real-time alarms, real-time PM data, network topology, etc.) to train the model using Reinforcement Learning (RL), which learns by trial and error. However, the embodiments described below do not necessarily need to attempt to train an AI model, but can use any AI model that has already been trained for Natural Language Processing (NLP).

The action recommendation systems may train the AI models to correlate the input data (e.g., real-time alarms, real-time PM data, network topology etc.) to an action which resolves the network issues. They might also use log input to train the model. However, as described below, the following embodiments may use telemetry data to create an appropriate “Prompt” and then use any AI-based LLM pre-trained for NLP to correlate the telemetry data to enterprise-specific content stored in a knowledge base.

For an AI model to be useful in the environment of action recommendation systems, a network operator may need to have plenty of inputs from a real network domain to train the model. It may take a long time to train such a model to have a useful AI-based solution. However, since the AI-based implementations described below do not necessarily involve AI training, they can be employed as long as the telemetry data is available. The following embodiments can make use of any NLP pre-trained LLM model.

The search engines described herein are configured in a novel approach with respect to conventional systems. That is, the search engines of the present disclosure are configured to combine both LLMs and cognitive search modules. Specifically, cognitive searching is a search technology that uses AI to quickly find relevant and accurate search results for various types of queries. Since enterprises often store large amounts of information (e.g., technical content, technical manuals, technical specifications, FAQs, internal articles, research reports, collaboration information, customer service guides, etc.) in large repositories, cognitive search technologies can perform similarity check through the various repositories to correlate data and discover answers to a user's query. For example, a user may ask, “How do we go about converting our systems to Enterprise 3.4 after widget ABC has been replaced with contraption gadget XYZ?” The cognitive search system may then be configured to map the question to relevant documents in the enterprise repositories, retrieve the relevant data, and return a specific answer.

It is believed that combining LLMs with cognitive search modules along with the real-time network telemetry data, network topology and network states has not been proposed until now. In particular, it is believed that the combined LLM/cognitive search system is unique in the environment of performing query searches in a multi-layer system (e.g., L0—optical, L1—Optical Transport Network (OTN), L2—Ethernet, L3—IP). For example, the L0-L3 multiple-layer system may be referred to as an IP over optical network, packet over optical network, packet over Dense Wavelength-Division Multiplexing (DWDM) network, MPLS over optical network, converged network, or the like. The combination of LLM and cognitive searching described herein is believed to overcome some problems with conventional systems and may be used reliably for answering queries about network assurance evaluations and recommend the corrective actions in case the multi-layer network suffers any failures including silent failures.

More specifically, conventional systems usually do not combine various types of data when characterizing problems in a network domain. For example, they might only look at one type at a time, such as only alarm notifications, only correlation, only network topology, only PMs, etc. Conventional alarm clearing procedures are generally limited to the context of a single alarm, threshold crossing, etc. Network problems often involve many alarms at different layers. Similarly, many alarms may be symptomatic of a larger issue. Without a big picture view, resolving individual alarms often does not address the underlying issues.

Also, conventional root cause analysis generally does not combine alarm and non-alarm data (e.g., PMs, OTDR tests, etc.) in determining the likely root cause, nor does it address the troubleshooting steps. It may reduce the set of alarms to troubleshoot, but each remaining alarm still has a separate clearing procedure, if any. PM prediction usually does not identify the reason for a negative trend, but instead it may only predict when it will become serious enough to violate a threshold, trigger an alarm, etc. Furthermore, conventional Software-Defined Networking (SDN) controllers might provide various ways to address assurance, troubleshooting, and debugging of a multi-layer network. However, these solutions usually do not consider AI or Machine Learning (ML) approaches. The systems and methods of the present disclosure are therefore configured to overcome the issues of the conventional systems by “enriching” or “enhancing” search solutions by incorporating the AI/ML models to provide enhanced information about a customer problem and how to resolve it.

The systems and methods of the present disclosure are configured to address the application of LLM and cognitive searching techniques to enhance network assurance in a multi-layer network domain (e.g., a packet over DWDM optical network where an overlay packet/IP/MPLS network rides over an underlay DWDM optical infrastructure). During assurance and troubleshooting of a multi-layer network, it would be beneficial for the network operator (or user) to find not only the faults in the enterprise network (or network domain) as soon as possible, but to also resolve the faults in a timely manner. In some embodiments, the idea of reactive problem detection based on alarms and multi-layer topology, as described in U.S. Pat. No. 11,533,216, incorporated by reference herein, may be utilized. For example, a Problem Analysis (PA) application described below may be included in a network management or control system. Also, the present disclosure may utilize dynamic workflow-based assurance in multi-layer networks.

### Example of Multi-Layer (Packet Over Optical) Network

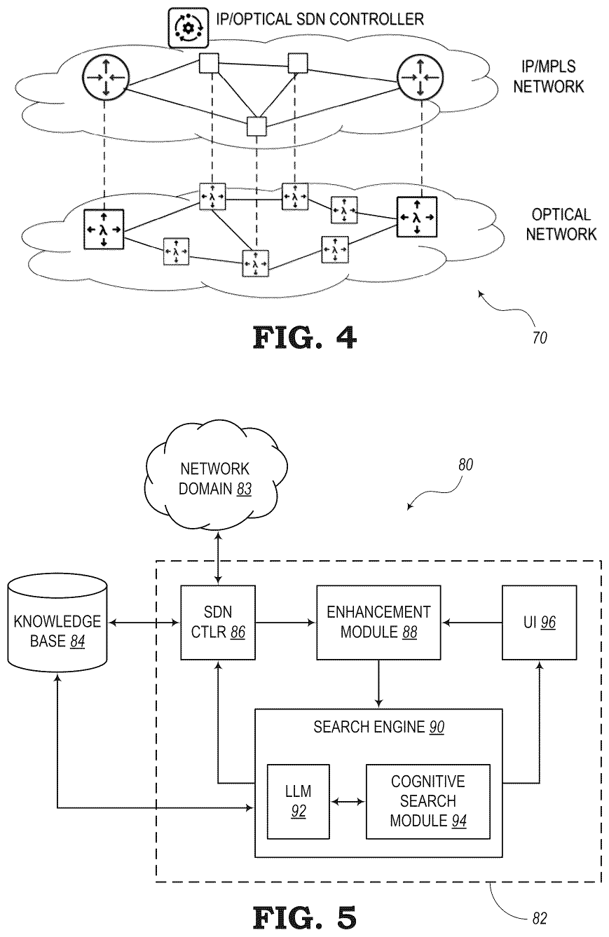

FIG. 4 is a diagram illustrating an example of a multi-layer network 70, which includes Internet Protocol (IP) and Multi-Protocol Label Switching (MPLS) equipment operating over an optical network. It may be noted that issues in the underlying layers (e.g., Layer 0 or optical layer, Layer 1 or OTN layer) may result in additional issues in the overlaid layers (e.g., Layer 2—Ethernet layer, Layer 3—IP layer).

One goal of the present disclosure is to complement both the existing query search systems and the existing troubleshooting apps as described herein. As such, one goal of the embodiments described herein is to enhance the multi-layer assurance and troubleshooting using the AI LLM and Cognitive Search tools in two aspects:

1) Enrich the operator's query about a network problem and provide useful insight into the issues. In this case, the LLM/Cognitive Search provides relevant information related to the problems.

2) To resolve and troubleshoot the network problem faster, provide more relevant actions to be performed in the network. In this area, an SDN controller may be used to bring relevant information about the current problem closer to the operator. The SDN controller apps can be executed manually or automatically in the network to resolve the issue.

In both of these aspects, the following information will be used by the LLM/Cognitive Search system to enhance the multi-layer assurance:
Real-time telemetry data and network inventory of multi-layer networks, such as an identity of Network Elements (NEs), types of the NEs, software releases running on the NEs, IP and Optical services, Traffic Engineering (TE) tunnels, Segment Routing (SR) policies, IP links, etc.
Enterprise resources and content, such as information stored in a “knowledge base.” The information may include internal technical documentation, knowledge articles, collaboration information, customer tickets, etc.
   Enterprise System with Search Capabilities

FIG. 5 is a block diagram illustrating an embodiment of an enterprise system 80 in which search queries may be performed. The enterprise system 80 may include a query system 82 that enables a user to inquire about a network domain 83 (e.g., multi-layer system 70). Also, the enterprise system 80 may include a knowledge base 84, which may include private information (e.g., enterprise data, equipment specs, technical journals, collaboration projects, etc.). The query system 82 is configured to obtain information from the network domain 83 (e.g., topology data, PM data, fault indications, etc.). Also, the query system 82 can consult with the knowledge base 84 to obtain useful information for performing a network assurance query, whereby the information may be stored locally and not available to the general public.

In particular, the query system 82 may include any suitable configuration for utilizing real-time network data with pre-stored enterprise documentation to enhance a network assurance query. As shown in FIG. 5, the query system 82 includes an SDN controller 86, an enhancement module 88, a search engine 90 having both an LLM 92 and a cognitive search module 94, and a User Interface (UI) 96. The UI 96 allows a user (e.g., network operator, admin, etc.) to enter a first search query, which can be processed, and then enter addition queries if he or she so chooses as a result of search results of the search engine 90. The SDN controller 86 is configured to interact with the network domain 83 and knowledge base 84 to obtain useful information related to a search query.

The enhancement module 88 may be configured to enhance the search queries by incorporating any relevant information regarding network assurance therein (such as real-time network telemetry PM data, network alarm notifications, network topology, network states, etc). In this way, the enhancement module 88 may feed the user's search queries along with relevant network assurance information as prompts into the search engine 90. Thus, the search engine 90 can thereby create better search results which is related to the network issue considering the real-time state of the network.

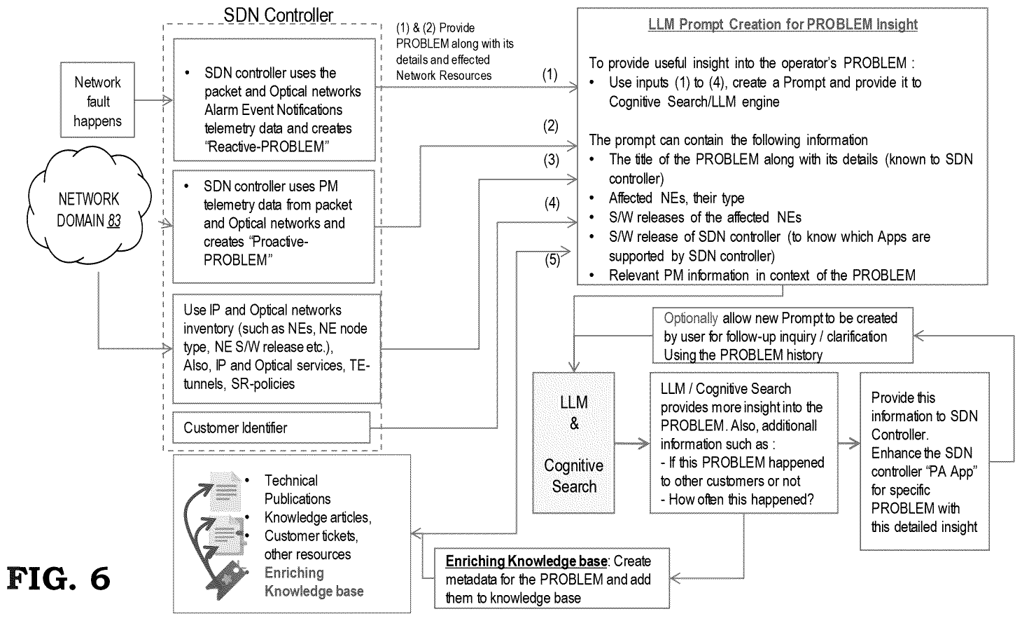

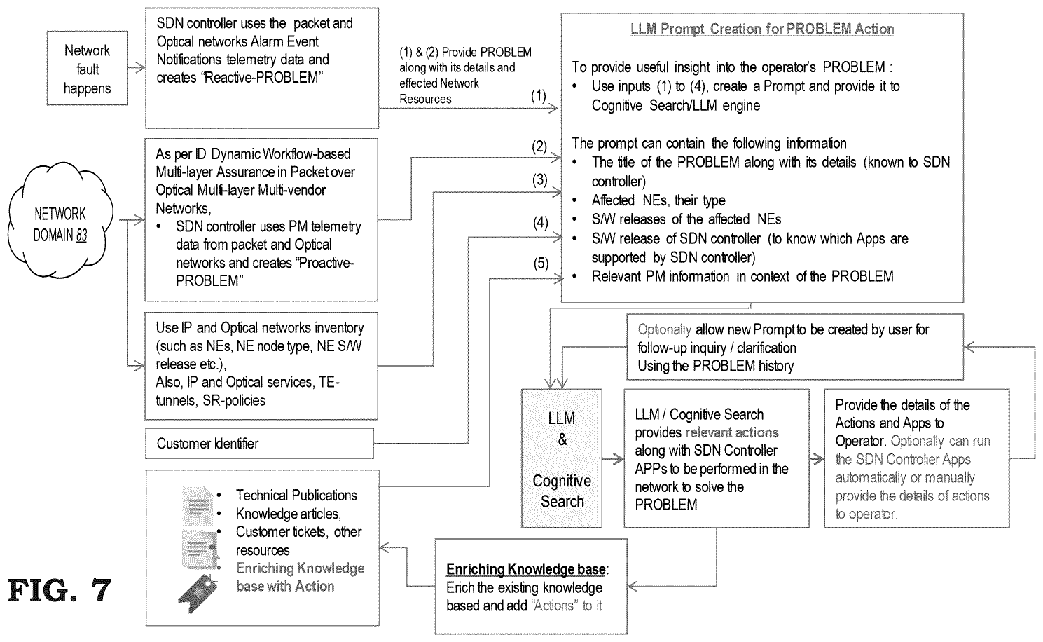

FIG. 6 is a flow diagram illustrating a network assurance use case related to finding an issue in the network domain 83. FIG. 7 is a flow diagram illustrating a corrective action use case related to determining corrective actions for any issue in the network domain 83.

Providing Insight into User's Query

According to a first aspect, the query system 82 may be configured to provide or incorporate useful insights (e.g., enrichments, enhancements, etc.) into the search queries, which can result in better search results. After detecting “pro-active” or “re-active” problems in the network domain 83, the search engine 90 of the query system 82 can use AI to perform a search query, which may include a combination of both the LLM 92 and cognitive search module 94. This can provide more relevant information and insight into detected problems, such as detailed information associated with user's query which is related to the current network issue. Also, this can enrich the knowledge base 84 by providing feedback of the search results back to the knowledge base 84, after the enhanced user query is fed. For example, the search engine 90 can create metadata regarding the issues in the network domain 83 and add this metadata to the knowledge base 84. In some cases, this information may be used for assisting other users with search queries. For example, the knowledge base 84 may store information about the user's network assurance queries, problems in the network domain 83, problems uncovered by multiple users, how often issues arise, etc.

Re-active solutions may be used when grouping the network issues based on “alarm event notifications” generated in a packet over optical network (e.g., network domain 83). When the SDN controller 86 receives these alarms, it correlates them, along with the affected network infrastructure and services, and creates a logical container called a “Re-active PROBLEM.”

Pro-active solutions may be used when grouping the network issues based on the collection of telemetry data (e.g., PM data, OAM results, etc.) in a real-time fashion from packet over optical networks (e.g., network domain 83). Based on telemetry collection from the network and analysis against thresholds or acceleration of negative trends, a “Pro-active PROBLEM” will be detected. Unlike the “re-active PROBLEM” in this case, the packet over optical network does not necessarily have any issue. The network performance may have declined, but there are no issues in the network at this time. For this reason, the term “pro-active” is introduced.

In some embodiments, the enhancement module 88 may be configured to create prompts along with the search queries. When a problem is detected in the network domain 83, the following information may be fed to an insight prompt creation component of the enhancement module 88:
a) The PROBLEM context along with some details which are detected by the SDN controller 86, such as a description of the PROBLEM along with its details (known to the SDN controller 86),
b) Affected Network Elements (NEs) of the network domain 83 that raise the Alarm Notifications and affected NEs that are violating one or more PM thresholds.
c) The packet and optical network inventory, such as the identity of the NEs (e.g., IP addresses, names, descriptions, etc.), NE types (e.g., IP components, optical components, Ethernet components, WDM components, multi-vendor nodes, etc.), and NE's software releases. This information can be used later by the LLM 92 and cognitive search module 94 to provide specific information which is relevant to these NEs.
d) Inventory of underlay and overlay services related to the context of the PROBLEM (e.g., L0 and L1 optical services, L2 and L3 IP or VPN services, TE tunnels, SR policies, IP links, etc.) which raised the Alarm Notifications or violated PM thresholds. This information can be used later by the LLM 92 and cognitive search module 94 to provide information which is relevant to these specific NEs.
e) Customer ID

Using these inputs, the enhancement module 88 is configured to construct an appropriate prompt and provide it to the search engine 90. The LLM and cognitive searches of the LLM 92 and cognitive search module 94 may occur in parallel, serially, cooperatively, etc., depending on different implementations. The search engine 90 searches enterprise content to find more relevant information in context of the current PROBLEM considering the current network topology and NEs. The search engine 90 can then provide insight into the operator's PROBLEM and feed insights back to the SDN controller 86 and/or knowledge base 84. Insights may be stored in the knowledge base 84 and may include 1) customer ID, 2) enterprise technical documentations, 3) customer documentation, 4) articles, 5) customer tickets, and/or other enterprise resources.

As shown in FIG. 5, the process can be recursive. For example, the SDN controller 86 can provide an environment for the operator to create a new prompt (e.g., using the UI 96) and keep the chat history in context of the PROBLEM. One goal of this use-case is to provide more insight into the current operator's issues and guide him or her to understand the issues faster and simpler.

In addition, the result of the Cognitive Search can be used to enrich the knowledge base 84 by creating some metadata regarding the PROBLEM and adding it to the knowledge base 84 in a database enrichment process. In some cases, the database enrichment process may create metadata dynamically that optionally may point to existing customer IDs, technology documentation, articles, and/or other enterprise knowledge. For example, if an existing PROBLEM had been seen with customer X and the query system 82 investigates a new issue for customer Y, information regarding both customers X and Y can be added to the knowledge base 84, which can help future investigation for other customers. This allows the knowledge base 84 to expand, which can then assist with finding relevant insights for future occurrences of the same or similar problems.

### Performing Resolution Actions Regarding the Search Query

A second aspect of the present disclosure involves acting upon information that is obtained as a result of the search query. Based on various factors pertaining to the network domain 83 and knowledge 84, and in response to a search query, the enterprise system 80 may be configured to enhance troubleshooting of the network domain 83 or multi-layer network to employ LLM and cognitive searching to find answers to network problems. In some embodiments, the enterprise system 80 may automatically reconfigure the network domain 83 or perform other reactive processes to remediate the problems and/or may instruct the network operator or technician to make corrections as needed to resolve the network problems.

In some embodiments, this resolution aspect of the present disclosure may include:
a) Providing more relevant and useful SDN controller 86 applications closer to the operator in order to help them resolve the PROBLEM in a timely manner.
b) Optionally, the SDN controller 86 can run resolution actions (e.g., using one or more apps) automatically or manually. Also, the SDN controller 86 in some cases may enrich the results with the search by the search engine 90 and provide details of the actions to operator or technician.

The inputs to the enhancement module 88 (e.g., relating to the first aspect) may include:
a) The PROBLEM context along with details which are detected by the SDN controller 86, such as PROBLEM description along with its details,
b) Affected NEs that raised the Alarm Notifications and/or violated PM thresholds.
c) The inventory of the network domain 83, such as the identity of the Network Elements (NEs) (e.g., IP address, name, description), NE's type, and software releases or versions running on the NEs. This information can be used later by the search engine 90 to provide specific information which is relevant to these NEs.
d) Inventory of underlay and overlay services related to context of the PROBLEM (e.g., L0 and L1 Optical services, IP L2/L3 VPN services, TE tunnels, SR policies, and IP links) which raised the Alarm Notifications or violated PM thresholds. This information can be used later by the search engine 90 to provide information which is relevant to these specific NEs.
e) Customer ID

Using these inputs, the enhancement module 88 may construct an appropriate prompt and provide the prompt, along with the search query and other information, to the search engine 90. The LLM 92 and cognitive search module 94 may operate cooperatively to search the following enterprise content (relevant to the current PROBLEM) considering the current network topology and network elements. The enhancement module 88 can therefore provide insight into the user's query regarding network problems or other network assurance metrics. Feedback to the knowledge base 84 (and/or SDN controller 86) may include a) Customer ID, b) network specification documentation, c) knowledge articles, d) customer tickets, and/or other enterprise resources.

An appropriately constructed prompt may result in the search engine 90 searching relevant content and providing to find more relevant actions along with apps of the SDN controller 86. These actions can then be executed in the network domain 83 to solve the one or more network PROBLEMS. The next step may be to execute these SDN applications in the network domain 83 either automatically or manually and provide the results to the operator.

### User Interfaces Examples

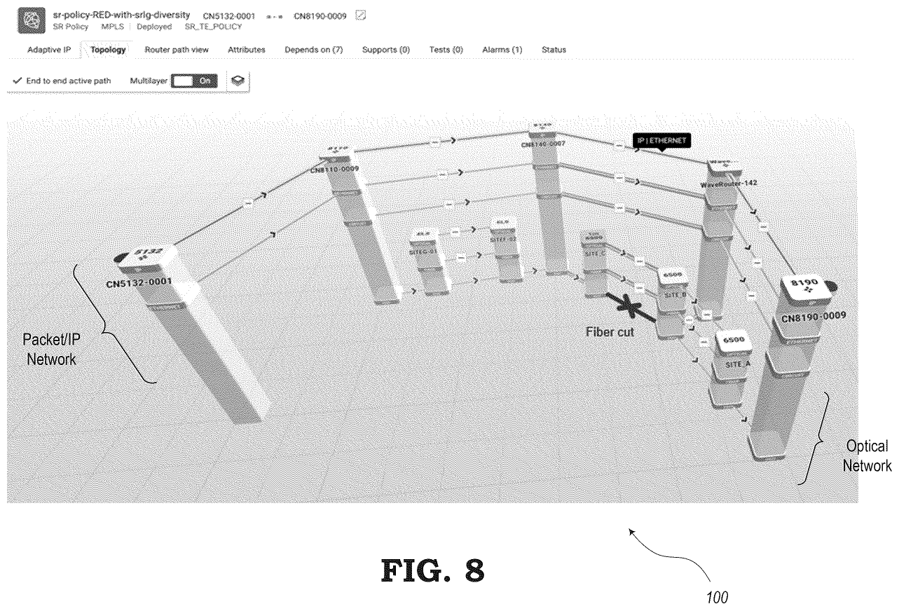

FIG. 8 is a screenshot 100 illustrating an embodiment of a graphical representation that may be provided on the UI 96 as a result of a search query with respect to the network domain 83 under test. In this example, the network domain 83 may be a multi-layer converged network, such as an IP over optical network, where overlay IP network runs on the underlying optical network. As shown, on Layer 0, there is a fiber cut or other type of fault that affects not only the optical network but also the IP components in the overlaying packet/IP network.

If a current network PROBLEM is related to the packet/IP network, a useful SDN controller 86 application to be executed may be an OAM test (e.g., Y.1731, TWAMP-Light, etc.) provided on the network element in the current PROBLEM context supporting them. Since the cognitive search module 94 may have all the necessary information about the network domain 83 (e.g., as depicted in FIG. 8), it should be possible for the search engine 90 to suggest appropriate IP OAM tests.

In addition, the corrective actions can be also added to the context of enriching the knowledge base 84. It helps to not only detect the PROBLEM, but also to suggest the corrective actions. Thus, a goal of both detection and remediation may be to allow customers easier troubleshooting of their multi-layer packet over optical network. The SDN controller 86 may also provide an environment for the user to allow new prompts to be created via the UI 96 for follow-up inquiries, clarifications, and new actions.

Referring again to FIG. 8, a fault (i.e., fiber cut) is detected on the optical layer. Again, the overlay IP links, TE tunnels, SR polices, L2/L3 VPN services, etc. on the packet/IP layer dependent on the underlying optical layer. As a result of the fault to the optical layer, packet layers and optical layers may generate multiple “Alarm Event Notifications” to the SDN controller 86.

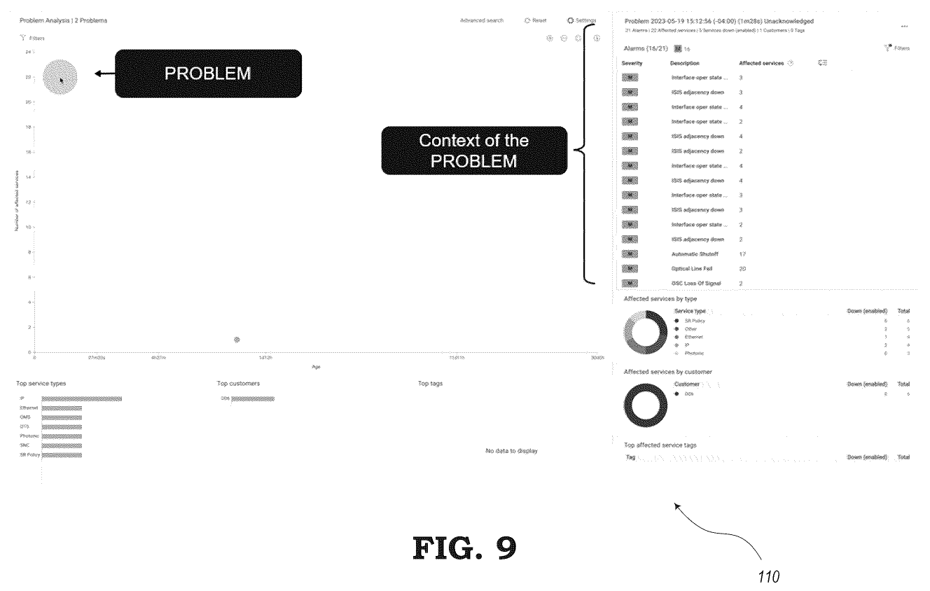

FIG. 9 is an example of a screenshot 110 displayed on the UI 96 (or SDN controller 86) showing the results of the search query. In some embodiments, the SDN controller 86 may include a Problem Analysis (PA) App which may consolidate all the alarms notifications into a single context called PROBLEM, shown in the screenshot 110 as a circle. The PROBLEM context known to SDN controller 86 may also be shown.

To further help the operator with more insight and useful details of the current issue, the following information will be fed as “LLM Insight Prompt” information to the search engine 90:
a) The PROBLEM and its context known to the PA App of the SDN controller 86.
b) The details of NEs which have raised alarm notifications for this PROBLEM (communicated to the SDN controller 86), since each alarm notification has an association to an object in the SDN controller 86. For example, this may include NE details, IP addresses, NE types, NE software release or version data, etc.
c) The details of underlay and overlay services which have raised alarm notifications for this PROBLEM.
d) Customer technical information, knowledge articles, collaboration, and/or other enterprise resources.

Using these inputs, an appropriate LLM Prompt will be generated which contains inputs (or at least a filtered list of inputs). The search engine 90 is configured to take the multi-layer components into account. In addition, each NE of the IP and optical networks can have specific software versions or releases. As a result, the search engine 90 can take this information into account as well. Furthermore, the IP and Optical layers can have specific services and tunnels. For example, the IP network can have only eVPN services. As a result, the search engine 90 can consider only eVPN services and disregard other IP services, such as L3 VPN services.

In summary, the generated prompt will be fed to the search engine 90, which is configured to return valuable information from the knowledge base 84 related to the current network assurance PROBLEM. The search result can also provide other useful information such as:
a) Whether or not this PROBLEM has happened to other customers (since customer tickets are one of the inputs). While this might not be data that is shared between customers (or different enterprises), a cloud-based system that offers these services for multiple customers can use this information for creating a fuller set of useful solutions.
b) How this PROBLEM was solved for other customers. For example, if a cloud-based service were used offering technical support and customer care, the service may record a summary or bulletin of multiple searches along with relevant data.
c) How often this PROBLEM has happened
d) If there are multiple potential root causes and one or more specific tests that can be done to narrow down the potential root causes
e) And more useful information

In the context of the network PROBLEM, the Problem Analysis (PA) App of the SDN controller 86 can be augmented by the information, which can help the user to understand the issue better and faster. Finally, the prompt creation (e.g., associated with the enhancement module 88) can make use of a chat history by providing a chat-like environment with NLP to the user to allow the user to further clarify the PROBLEM by asking follow-up questions.

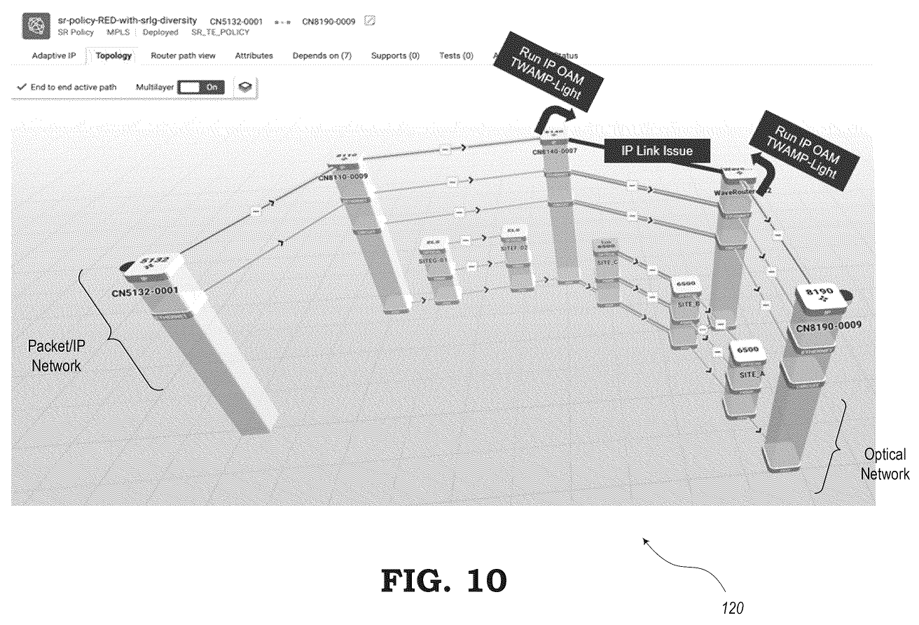

FIG. 10 is another example of a screenshot 120 illustrating a graphical representation of more search results associated with the network domain 83 or other similar multi-layer network. The PROBLEM in this example is related to an IP link issue in the packet/IP network resulting in packet loss. To get more information about this IP link, the search engine 90 may suggest, for instance, running IP OAM in context of the IP link. Since the search engine 90 may be aware of IP network elements, NE type, and NE software versions on each endpoint of this IP link, it knows which IP OAM tests are supported by both network elements. As a result, the search engine 90 can suggest, for instance, running appropriate IP OAM TWAMP-Light tests. Also, the SDN controller 84 may be configured to suggest IP OAM tests and then run them either automatically or manually. The results can be provided to the operator via the UI 96 and can be added to the context of the PROBLEM on the SDN controller 84.

### Additional Search System Embodiments

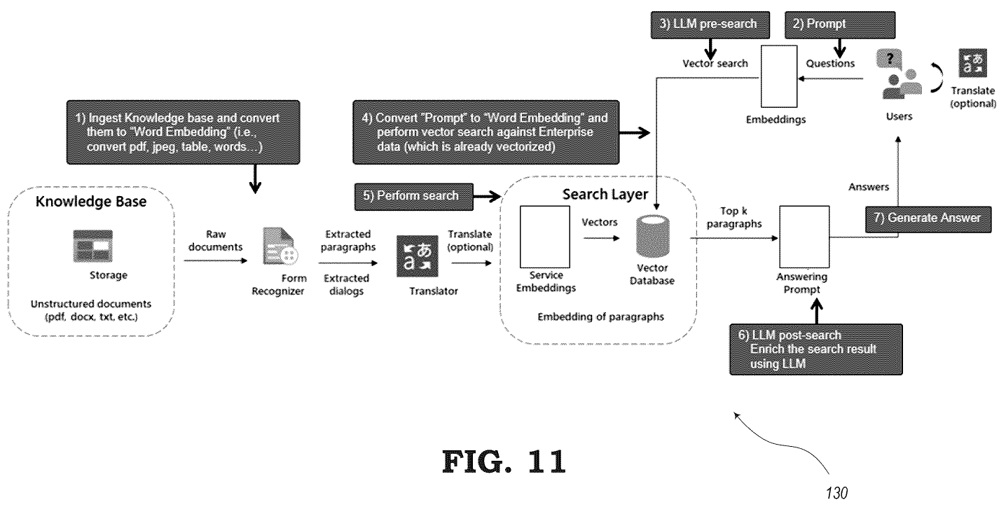

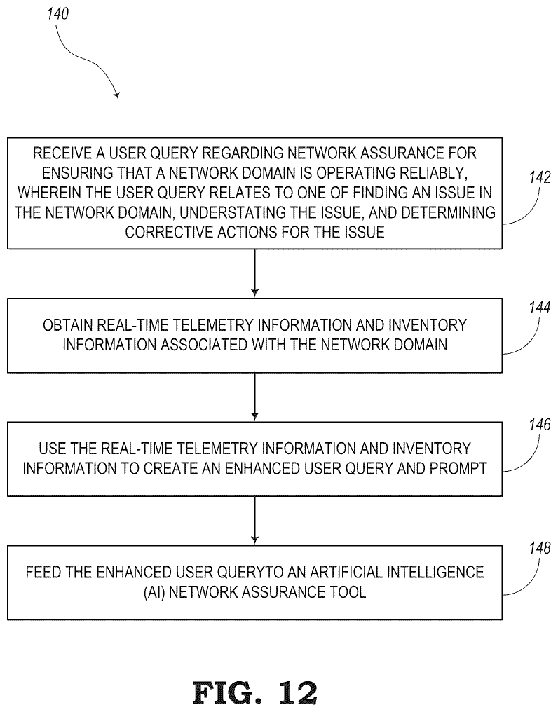

FIG. 11 is a diagram illustrating an embodiment of a search system 130. As shown, the search system 130 may include a knowledge base (e.g., Azure storage) that stores unstructured documents in various formats (e.g., pdf, docx, txt, etc.). Raw documents can be sent to a form recognizer. In a first search step, the form recognizer may ingest the documents from the knowledge base, which may convert the documents to “word embedding” (e.g., convert pdf, jpeg, table, words, etc.). Extracted paragraphs and dialogs may be provided from the form recognizer to a translator.

A second search step in the search system 130 includes receiving a prompt or question from a user. Translation may be used if necessary. In a third step, the question is provided to an AI embedding device (e.g., OpenAI Embedding), which provides LLM pre-search data. In a fourth search step, a search layer converts the prompt to word embeddings and performs a vector search against enterprise data, which may already be vectorized. The search layer may include service embeddings supplying vectors to a vector database. The LLM pre-search may include a vector search that is also supplied to the vector database. A fifth step includes the search layer performing a search. Next, in a sixth search step, the top k paragraphs from the search layer are supplied to an answering prompt. The LLM post-search is configured to enrich the search results using LLM. In a seventh step, answers from the answering prompt are configured to generate answers that are provided to the user.

Furthermore, a real-time network input system may use PA context and real-time network telemetry and inventory about the state of the network. This may include NE states, PMs, NE software releases, management and control system releases, supported features of the management and control system, etc. Enhancements may be made for multi-layer assurance using AI LLM. The real-time network inputs may provide additional data ingestion to the Azure cognitive search device. Also, the real-time network inputs may be provided to the user's prompt.

### Search Query Method

FIG. 10 is a flow diagram illustrating an embodiment of a method 140 for performing a query search regarding network assurance of a network domain. As illustrated in FIG. 10, the method 140 includes a step of receiving a user query regarding network assurance for ensuring that a network domain is operating reliably, wherein the user query relates to one of finding an issue in the network domain, understating the issue, and determining corrective actions for the issue, as indicated in block 142. The method 140 also includes a step of obtaining real-time telemetry information and inventory information associated with the network domain, as indicated in block 144. In addition, the method 140 includes using the real-time telemetry information and inventory information to create an enhanced user query, as indicated in block 146. The method 140 further includes a step of feeding the enhanced user query to an Artificial Intelligence (AI) network assurance tool, as indicated in block 148.

According to some embodiments, the method 140 may further include a step of feeding enterprise content stored in a knowledge base to the AI network assurance solution, where the enterprise content includes one or more of proprietary technical specifications, internal articles, internal collaboration data, and customer data. The method 140 may also include a step of providing metadata to the knowledge base to enhance the enterprise content based on results from the AI network assurance solution provided in response to the user query.

In some embodiments, the AI network assurance solution described in block 148 may be configured to troubleshoot the network domain, determine one or more issues regarding the network domain, and enable the manual or automatic resolution of the one or more issues. The AI network assurance solution may include a Large Language Model (LLM) and a Cognitive Search module. In some implementations, the AI network assurance solution may include a Retrieval-Augmented Generation (RAG) component configured to obtain relevant context from the network domain. The network domain described in the method 140 may be an IP-over-optical domain arranged at multiple layers. The inventory information may define network equipment and software release data at each of the multiple layers. The step of creating the enhanced user query (block 146) may further include a step of adding useful insights based on one or more characteristics of the network domain.

The real-time telemetry information (block 144) may include Performance Monitoring (PM) data measured with respect to Network Elements (NEs) and links connecting the NEs, thereby enabling the AI network assurance solution to determine one or more proactive problems. The real-time telemetry information may also include one or more alarm events representing one or more potential issues in the network domain, thereby enabling the AI network assurance solution to determine one or more reactive problems. The method 140 may further include a step of detecting the network assurance by determining one or more of optimizations of the network domain, security of the network domain, health of the network domain, fault management of the network domain, and configuration or capacity planning of the network domain. The AI network assurance solution (block 148) may be part of a Software-Defined Networking (SDN) controller.

With respect to conventional search systems, the systems and methods of the present disclosure may include certain points of novelty. For example, one point may include combining features or aspects to enhance the multi-layer assurance and troubleshooting of packet over optical networks. Some features or aspects may include the idea of reactive problem detection based on alarms and multi-layer topology, as described in U.S. Pat. No. 11,533,216, and the idea of dynamic workflow-based multi-layer assurance in multi-vendor packet over optical networks. Another point may include AI LLM and Cognitive Search combinations to enrich the operator's PROBLEM and provide useful insight into the operator's issue. In this case, the LLM/Cognitive Search provides relevant information related to operator's problem, which would otherwise be difficult to locate (e.g., information from various documents, internal sources, etc.). Also, the LLM/Cognitive Search may resolve and troubleshoot the PROBLEM faster, provide more relevant actions (e.g., using SDN Apps) to be performed in the network. In this area, the SDN controller can bring more relevant SDN controller Apps, which are related to a current PROBLEM, to the attention of the operator. These SDN controller Apps can be executed manually or even automatically to help resolve the issue. This reduces both the required level of operator expertise in the problem space and the level of familiarity required with the SDN controller.

Another point of novelty involves combining the following real-time network data with nearly-static resources: 1) real-time telemetry data and network inventory of packet and optical networks such as network elements (NEs), type of network elements, S/W releases of network elements, IP and Optical services, TE-tunnels, SR-policies, IP links etc., and 2) nearly-static enterprise resources, contents, customer technical publications, knowledge articles and customer tickets.

An additional point of novelty may include an approach to enrich a knowledge base using the result of LLM and Cognitive searches by creating metadata for the operator's PROBLEM and by adding them to the knowledge base. This allows the subsequent troubleshooting easier if the future network issue is the same or similar to an existing operator's PROBLEM.

Additionally, another novel point is that the systems and methods are intended to cover multi-layer packet over optical networks, packet networks, or optical networks. In other words, the assurance and troubleshooting of a wide variety of optical and packet networks are supported by the present disclosure. This can be done especially when combined with the other novel aspects. Also, it facilitates troubleshooting of multi-layer problems by operators who may not necessarily be experts in all layers of the network.

By utilizing a broader set of input data and considering a variety of data sources, the present embodiments can improve upon existing concepts such as alarm-to-service correlation, root cause analysis, and alarm clearing procedures. In doing so, the systems and methods can provide better insight into what the problem is, what is causing it, and how to go about resolving it.

Moreover, the present disclosure may have the following characteristics to address the shortcomings of the conventional systems. The systems and methods described herein can provide a dynamic nature of enriching the customer PROBLEM. This helps the operators to understand the existing issue better with more information provided by LLM/Cognitive Search. Also, the systems and methods can help the operators to use the relevant SDN controller applications (or SDN Apps) to resolve the issue faster and more efficiently. By enriching the knowledge base, the systems and methods of the present disclosure can provide relationships between customer IDs, their PROBLEMS and existing context in a management and control system and knowledge base. The present embodiments help to resolve existing issues better with more information provided by the LLM/Cognitive Search.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments. Also, in the claims, the terms “comprise,” “comprises,” “comprising,” “include,” “includes,” and “including” are intended to be non-limiting and open-ended. These terms specifically list essential elements or steps but do not exclude additional elements or steps. This applies even when a claim or series of claims includes more than one of these terms.

What is claimed is:

1. A non-transitory computer-readable medium configured to store a computer program having logical instructions for enabling one or more processing devices to perform steps of:
receiving a user query regarding network assurance for ensuring that a network domain is operating reliably, wherein the user query relates to one of finding an issue in the network domain, understating the issue, and determining corrective actions for the issue;
obtaining real-time telemetry information and inventory information associated with the network domain;
using the real-time telemetry information and inventory information to create an enhanced user query; and
feeding the enhanced user query to an Artificial Intelligence (AI) network assurance solution.

2. The non-transitory computer-readable medium of claim 1, wherein the logical instructions further enable the one or more processing devices to perform a step of feeding enterprise content stored in a knowledge base to the AI network assurance solution, the enterprise content including one or more of proprietary technical specifications, internal articles, internal collaboration data, and customer data.

3. The non-transitory computer-readable medium of claim 2, wherein the logical instructions further enable the one or more processing devices to perform a step of providing metadata to the knowledge base to enhance the enterprise content based on results from the AI network assurance solution provided in response to the enhanced user query.

4. The non-transitory computer-readable medium of claim 1, wherein the AI network assurance solution is configured to troubleshoot the network domain, determine one or more issues regarding the network domain, and enable a manual or automatic resolution of the one or more issues.

5. The non-transitory computer-readable medium of claim 1, wherein the AI network assurance solution includes a Large Language Model (LLM) and a Cognitive Search module.

6. The non-transitory computer-readable medium of claim 1, wherein the AI network assurance solution includes a Retrieval-Augmented Generation (RAG) component configured to obtain relevant context from the network domain.

7. The non-transitory computer-readable medium of claim 1, wherein the network domain is a packet-over-optical domain arranged at multiple layers, and wherein the inventory information defines network equipment and software release data at each of the multiple layers.

8. The non-transitory computer-readable medium of claim 1, wherein the step of creating the enhanced user query includes a step of adding useful insights based on one or more characteristics of the network domain.

9. The non-transitory computer-readable medium of claim 1, wherein the real-time telemetry information includes Performance Monitoring (PM) data measured with respect to Network Elements (NEs) and links connecting the NEs, thereby enabling the AI network assurance solution to determine one or more proactive problems.

10. The non-transitory computer-readable medium of claim 1, wherein the real-time telemetry information includes one or more alarm events representing one or more potential issues in the network domain, thereby enabling the AI network assurance solution to determine one or more reactive problems.

11. The non-transitory computer-readable medium of claim 1, wherein the logical instructions further enable the one or more processing device to detect the network assurance by determining one or more of optimizations of the network domain, security of the network domain, health of the network domain, fault management of the network domain, and configuration or capacity planning of the network domain.

12. The non-transitory computer-readable medium of claim 1, wherein the AI network assurance solution is part of a Software-Defined Networking (SDN) controller.

13. The non-transitory computer-readable medium of claim 1, wherein the user query relates to determining corrective actions for the issue, and wherein the logical instructions further enable the one or more processing device to provide details of the determined corrective actions.

14. A system comprising:
a processing device; and
a memory device configured to store computing logic having instructions that, when executed enables the processing device to
receive a user query regarding network assurance for ensuring that a network domain is operating reliably, wherein the user query relates to one of finding an issue in the network domain, understating the issue, and determining corrective actions for the issue,
obtain real-time telemetry information and inventory information associated with the network domain,
use the real-time telemetry information and inventory information to create an enhanced user query, and
feed the enhanced user query to an Artificial Intelligence (AI) network assurance solution.

15. The system of claim 14, wherein the instructions further enable the processing device to
feed enterprise content stored in a knowledge base to the AI network assurance solution, the enterprise content including one or more of proprietary technical specifications, internal articles, internal collaboration data, and customer data, and
provide metadata to the knowledge base to enhance the enterprise content based on results from the AI network assurance solution provided in response to the enhanced user query.

16. The system of claim 14, wherein the AI network assurance solution is configured to troubleshoot the network domain, determine one or more issues regarding the network domain, and enable manual or automatic resolution of the one or more issues.

17. The system of claim 14, wherein the AI network assurance solution includes one or more of a Large Language Model (LLM), a Cognitive Search module, and a Retrieval-Augmented Generation (RAG) component configured to obtain relevant context from the network domain.

18. A method comprising steps of:
receiving a user query regarding network assurance for ensuring that a network domain is operating reliably, wherein the user query relates to one of finding an issue in the network domain, understating the issue, and determining corrective actions for the issue;
obtaining real-time telemetry information and inventory information associated with the network domain;
using the real-time telemetry information and inventory information to create an enhanced user query; and
feeding the enhanced user query to an Artificial Intelligence (AI) network assurance tool.

19. The method of claim 18, wherein the network domain is a packet-over-optical domain arranged at multiple layers, wherein the inventory information defines network equipment and software release data at each of the multiple layers, and wherein creating the enhanced user query includes a step of adding useful insights based on one or more characteristics of the network domain.

20. The method of claim 18, wherein the real-time telemetry information includes one or more of a) Performance Monitoring (PM) data measured with respect to Network Elements (NEs) and links connecting the NEs, and b) one or more alarm events representing one or more potential issues in the network domain.
